(19) United States
(12) Patent Application Publication
(10) Pub. No.: US 2014/0106766 A1
(43) Pub. Date: Apr. 17, 2014

(54) METHOD FOR SCHEDULING USERS IN A CELLULAR ENVIRONMENT FOR APPLYING PARETO OPTIMAL POWER CONTROL, SCHEDULER AND WIRELESS COMMUNICATION NETWORK

(71) Applicant: NTT DOCOMO, Inc., Tokyo (JP)

(72) Inventors: Harald BURCHARDT, Munich (DE); Sinan SINANOVIC, Munich (DE); Harald HAAS, Munich (DE); Guenther AUER, Munich (DE)

(73) Assignee: NTT DOCOMO, Inc., Tokyo (JP)

(21) Appl. No.: 14/106,046

(22) Filed: Dec. 13, 2013

Related U.S. Application Data
(63) Continuation of application No. PCT/EP2012/061341, filed on Jun. 14, 2012.

(30) Foreign Application Priority Data
Jun. 16, 2011 (EP) 11170113.2-2411

(51) Int. Cl. H04W 72/12; H04W 52/04

(52) U.S. Cl. CPC H04W 72/1231; H04W 52/04
USPC 455/452.1

(57) ABSTRACT

An approach for scheduling users in a cellular environment such that a Pareto optimal power control can be applied, wherein in each cell of the cellular environment there are a plurality of user, includes scheduling users such that a number of groups of interfering users from different cells which fulfill a feasibility condition for the Pareto optimal power control is maximized.

### RELATED APPLICATIONS

This application is a continuation of PCT/EP2012/061341 filed on Jun. 14, 2012, which claims priority to the European Application No. 11170113.2-2411 filed on Jun. 16, 2011. The entire contents of these applications are incorporated herein by reference.

Embodiments of the invention relate to the field of wireless communication networks, more specifically to approaches for joint scheduling and power control in a cellular environment, in particular to the scheduling of users such that Pareto optimal power control (POPC) can be directly applied.

### BACKGROUND OF THE INVENTION

When considering scheduling and power control in the uplink of a cellular orthogonal frequency division multiple access (OFDMA) system, uplink power control is an important aspect and is particularly relevant for cellular networks. FIG. 1 is a schematic representation of a portion of such a cellular network comprising two base stations Rx₁ and Rx₂ receiving on the uplink connection signals from mobile stations or mobile users Tx₁ and Tx₂. Mobile stations Tx₁ communicate with base station Rx₁, while mobile station Tx₂ communicates with base station Rx₂. As shown in FIG. 1, several transmissions occur concurrently so that interference may occur. In the example shown in FIG. 1 the transmission signal transmitted by mobile station Tx₂ for communicating with the associated base station Rx₂ is also received at the base station Rx₁ as an interference transmission I₂₁. Interference may severely affect the attainable spectral efficiency in the network. Therefore, for avoiding negative effects on the spectral efficiency scheduling and power control in the uplink connections between the transmitters and the receivers are important aspects. It is noted that the same applies for a downlink connection in such a network in which a transmission occurs from the respective base stations to the associated users, wherein a transmission from a base station may also be received as an interference communication at other mobile stations. When considering FIG. 1, in the down link scenario the base stations would be in the transmitters Tx₁, Tx₂ and the mobile stations would be the receivers Rx₁ and Rx₂.

For addressing the problem of interference in wireless communication systems, either in the uplink connection or in the downlink connection, in general, scheduling and power control are separated, i.e. one approach is used for scheduling, and another approach is used for power control. However, this not only generates additional scheduling complexity but also may reduce the optimality of the solution (see, for example, T. ElBatt and A. Ephremides, “Joint Scheduling and Power Control for Wireless ad hoc Networks,” IEEE Transactions on Wireless Communications, vol. 3, no. 1, pp. 74-85, 2004).

Scheduling in OFDMA networks in the uplink and downlink is described in X. Wang, G. B. Giannakis, and Y. Yu, “Channel-Adaptive Optimal OFDMA Scheduling,” in Proc. of 41st Annual Conference on Information Sciences and Systems CISS, Baltimore, Md., USA, March 2007, pp. 536-541, where an on-line algorithm based on the water-filling solution is proposed. While this approach delivers an optimal resource block allocation (RB allocation), the throughput fairness among the users is not considered. A computationally efficient power control mechanism is described in D. Kivanc, G. Li, and H. Liu, “Computationally Efficient Bandwidth Allocation and Power Control for OFDMA,” IEEE Transactions on Wireless Communications, vol. 2, no. 6, pp. 1150-1158, 2003, where the problem of minimizing target power is described. However, the joint subcarrier and power allocation is split into two stages, thus disregarding the dependence between the two. In addition, two greedy allocation algorithms are suggested, so that the fairness consideration is reduced to a minimum rate constraint.

A further known approach is the so-called multi-carrier proportional fair (PF) scheduling, which is described in H. Kim, K. Kim, Y. Han, and S. Yun, “A Proportional Fair Scheduling for Multicarrier Transmission Systems,” in Proc. of 60^{th} Vehicular Technology Conference, VTC, vol. 1, September 2004, pp. 409-413. Multi-carrier PF scheduling is based on a generic PF scheduling metric, the maximization of the sum of logarithmic average user rates. Although performance gains over round-robin schedulers are achieved, the high algorithm complexity makes it unsuitable for fourth generation (4G) OFDMA systems. In R. Kwan, C. Leung, and J. Zhang, “Proportional fair multiuser scheduling in LTE,” IEEE Signal Processing Letters, vol. 16, no. 6, pp. 461-464, jun 2009 a lower complexity suboptimal proportional fair scheduler (PFS) is described, where subcarriers are scheduled sequentially. However, this causes large sum throughput losses, especially when the user signal-to-interference-plus-noise ratio (SINR) distribution is irregular, which is generally the case in cellular networks. In M. Khedr, I. El-Rube, Y. Hanafy, and H. Abou-Zeid, “Subcarrier opportunistic proportional fair scheduling for OFDMA systems,” in Proc. of 4th International Conference on Internet ICI, Tashkent, September 2008, pp. 1-5, subcarrier opportunistic PF scheduling is described, where a subcarrier is assigned to the user with the best weighted response relative to the average response of the other users on the subcarrier. While this scheme provides reasonable capacity-fairness gains, it is only suitable for the downlink and might have to be modified appropriately for the uplink.

The above-described approaches known in the art deal with scheduling, which are separate from power control approaches. For example, power control for OFDM networks involves a fractional power control (FPC) scheme as, for example, described in A. Rao, “Reverse Link Power Control for Managing Inter-Cell Interference in Orthogonal Multiple Access Systems,” in Proc of Vehicular Technology Conference (VTC), October 2007, pp. 1837-1841. This scheme offers a slight adaptation to conventional power control to trade off spectral efficiency and cell-edge bit rate. However, many users will not achieve their SINR targets, so that user throughput will suffer. An extension to FPC is described in Z. Li, Y. Wang, and D. Yang, “A Novel Power Control Scheme in OFDMA Uplink,” in Proc. of International Conference on Signal Processing (ICSP), 2008, pp. 2880-2883, where the power control expression takes into account interference caused to neighboring cells. While this achieves a modest capacity increase, the mean level of interference to other cells is not reduced, rather only the variance is. In L. K. Tee, C. van Rensburg, and J.-A. Tsai, “Uplink Power Control for an OFDMA Mobile Cellular System,” in Proc. of the Vehicular Technology Conference, Baltimore, Md., September/October 2007, on the other hand, a closed-loop power control is described which offers significant gains in the user throughput and transmit power, however these are achieved for very low SINRs only, whereas almost no benefits can be seen in the high SINR range.

### SUMMARY OF THE INVENTION

According to an embodiment, a method for scheduling users in a cellular environment such that a Pareto optimal power control can be applied, wherein in each cell of the cellular environment there are a plurality of users, may have the steps of: scheduling users such that a number of groups of interfering users from different cells which fulfill a feasibility condition for the Pareto optimal power control is maximized, wherein scheduling includes: searching all combinations of users, each combination including one user in a neighboring cell; adding to a set of candidates each combination which fulfills the feasibility condition; and allocating the users until all users in the set of candidates have been allocated, wherein allocating starts with users being part in the fewest combinations, and wherein for a three cell scenario the feasibility condition is as follows:

F₁₂F₂₁+F₁₃F₃₁+F₂₃F₃₂+F₁₂F₂₃F₃₁+F₁₃F₂₁F₃₂<1

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of user i, and

G_{j,v}_{ᵢ} is the path gain between user j and the BS vᵢ of MS i.

According to another embodiment, a computer program product may have instructions to perform a method of claim 1 when executing the instructions on a computer.

According to another embodiment, a scheduler for a wireless network may have a plurality of cells, each including a plurality of users, the scheduler being configured to schedule the users in accordance with claim 1.

According to another embodiment, a wireless network may have a plurality of cells, each including a plurality of users, and a scheduler of claim 11.

Embodiments of the invention provide a scheduler for a wireless network having a plurality of cells, each including a plurality of users, the scheduler being configured to schedule the users in accordance with embodiments of the invention.

Embodiments of the invention provide a wireless network comprising a plurality of cells, each including a plurality of users, and a scheduler in accordance with embodiments of the invention.

Yet another embodiment of the invention provides a computer program product comprising a program including instructions stored by a computer readable medium, the instructions executing a method in accordance with embodiments of the invention when running the program on a computer.

In accordance with an embodiment scheduling comprises iterating through combinations of users in the cells, and allocating resource blocks to the users such that the combinations fulfilling the feasibility condition are scheduled as interferers.

In accordance with an embodiment scheduling comprises searching all combinations of users, each combination including one user in a neighboring cell, adding to a set of candidates each combination which fulfills the feasibility condition, and allocating the users until all users in the set of candidates have been allocated, wherein allocating starts with users being part in the fewest combinations. Scheduling the users may be repeated until all users in the set of candidates have been scheduled.

In accordance with an embodiment, in case there are users which are not part of any combination fulfilling the feasibility condition, scheduling further comprises deactivating for each user one link, adapting a SINR target for each user to maintain system spectral efficiency, adding each combination of users which fulfills a modified feasibility condition to a further set of candidates, and allocating the users until all users in the further set of candidates have been allocated, wherein the allocation starts with a user being part in the fewest combinations. Deactivating, adapting, adding and allocating may be repeated for users not part of any combination fulfilling the modified feasibility condition until all links to users in neighboring cells have been deactivated.

In accordance with an embodiment for a three cell scenario the feasibility condition is as follows:

F₁₂F₂₁+F₁₃F₃₁+F₂₃F₃₂+F₁₂F₂₃F₃₁+F₁₃F₂₁F₃₂<1

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of user i, and

G_{j,v}_{ᵢ} is the path gain between user j and the BS vᵢ of MS i.

In accordance with an embodiment the method further comprises switching off the links to users in neighboring cells, in case of one or more users in a cell that cannot form a combination fulfilling the feasibility condition. The links may be switched off over a plurality of consecutive time slots, wherein the SINR target of the remaining links is changed for maintaining the system spectral efficiency. The SINR target of the remaining links may be changed as follows:

$${γ}_{( 1 ) , up}^{*} = \frac{{\prod }_{j}^{K} ( 1 + {γ}_{j}^{*} )}{1 + {γ}_{( 2 ) , up}^{*}} - 1 ,$$

where γ_{(i),up}* represents the updated SINR target of the i^{th} remaining link.

In accordance with an embodiment the method may further comprise grouping three cells with coinciding beam patterns to form a cluster shielded from neighboring sectors' interference, applying the scheduling the these three cells, and tessellating the clusters over the cell environment, thereby applying the scheduling separately to each cluster.

In accordance with an embodiment for each combination fulfilling the feasibility condition the method comprises calculating the Pareto optimal power allocation and assigning it to the users.

Embodiments of the invention provide an approach for obtaining an optimal power control for users or mobile stations in a cellular environment using Pareto optimal power control, i.e. adjusting the transmit power such that an achieved SINR of a receiver cannot be increased without reducing the SINR of another receiver. Pareto optimal power control (POPC) is described in A. Goldsmith, Wireless Communications University Press, 2005. In accordance with Pareto scheduling multiple interfering users in neighboring cells are scheduled such that the number of groups of interferers which fulfill a feasibility condition for Pareto optimal power control is maximized. After applying the Pareto optimal power control each user or mobile station in each group will achieve its SINR target with Pareto optimal transmit power. Thus, embodiments of the invention address the issues of scheduling a power control in the uplink of a cellular OFDM system, however, in accordance with further embodiments, the inventive approach can also be implemented in the downlink.

The above-described known approaches for solving the resource and power allocation problems separate a resource allocation problem and the power location problem in an attempt and solve them separately as an optimization problem. Even most “joint” solutions to the problems provide separate stages for resource, power and rate allocations (see, for example, the publications of T. ElBatt, X. Wang and D. Kivanc mentioned above). Hence, these approaches reduce the optimality of the solutions provided. Contrary thereto, the inventive approach, by combining two allocation stages, allows to schedule users such that the power control stage becomes simply a power assignment procedure, rather than needing to calculate the useful transmission powers based on an optimal resource allocation. Further, by increasing the applicability of POPC in the network, the users and system target spectral efficiencies will be met with Pareto optimal transmit powers.

In accordance with the embodiments of the invention, Pareto optimal scheduling (POS) is presented, which is a novel scheduling mechanism based on Pareto optimal power control (POPC). Mobile stations (MS_{S}) are scheduled based on path gains and signal-to-interference-plus-noise ratio (SINR) targets such that the conditions for POPC are fulfilled. Further, users are scheduled in such a manner that the number of concurrently transmitting MS_{S} is maximized. In accordance with further embodiments, a stepwise removal (SR) algorithm is provided for a situation where links do not meet the conditions for POPC. In such a case, the links are removed in order for other MS_{S} to achieve their SINR targets, while the targets of the other (remaining) MS_{S} updated to prevent losses in system spectral efficiency caused by the link removals.

Embodiments of the invention are applicable for cellular networks as well as for heterogeneous networks composed of micor, pico and femto-cells.

Embodiments of the invention are advantageous as they provide for a possibility to optimize the interference coordination such that the system spectral efficiency is maximized which allows to more efficiently use the spectral resources and, therefore, to also reduce the costs per transmitted bit. Also, embodiments of the invention are advantageous as the issues of scheduling and power control are solved jointly and simultaneously such that a loss of solution optimality due to a separation of these steps is avoided. In addition, the power usage of the system is minimized due to POPC. Further, all scheduled users (i.e. users that have been assigned RBs and that have not been removed through SR) achieve the SINR targets, and hence also the spectral efficiency target is achieved. Further, an enhanced sum-rate through increase in spatial reuse is achieved as well as a boost in cell-edge user throughput since all users achieve the SINR targets. Also energy efficiency is significantly improved through power control.

Scheduling may take place either in the respective base stations communicating with each other via a backbone network or in an entity at a higher level in the network, for example in the base station of the macro-cell.

### BRIEF DESCRIPTION OF THE DRAWINGS

Embodiments of the present invention will be detailed subsequently referring to the appended drawings, in which:

FIG. 1 is a schematic representation of a portion of a cellular network;

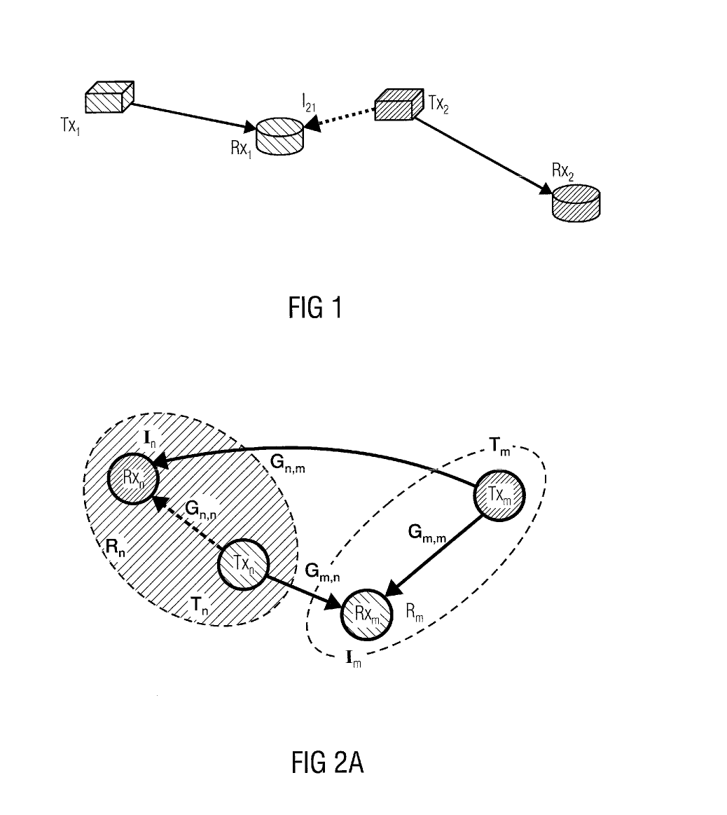

FIGS. 2A through 2C show schematic representations of a communication system, wherein FIG. 2A depicts a schematic representation of two transmitters, and wherein FIG. 2B and FIG. 2C depict the strengths of a receive signal, a noise signal and an interference signal at two receivers;

FIGS. 3A and 3B show schematic representations of a three-cell network (FIG. 3A) and the available resource blocks (FIG. 3B);

FIG. 4 shows an example of a SR algorithm with SINR target updates over multiple time slots;

FIG. 5 shows a three-cell system similar to the one in FIG. 3A;

FIG. 6 depicts a sectorized cellular network with a three-cell scheduler being tessellated over its cells;

FIG. 7 shows a graph depicting the range of values for c and d in Eq. (4) for which all eigenvalues of F are within the unit circle;

FIGS. 8A and 8B show the POS algorithm in accordance with an embodiment of the invention;

FIG. 9 shows a graph of the spectral efficiency results for various power allocation techniques for varying SINR targets and inter-site distances (ISDs); and

FIG. 10 shows a graph of the system power usage results for the various power control techniques.

### DETAILED DESCRIPTION OF THE INVENTION

Pareto optimal scheduling (POS) focuses on scheduling users such that Pareto optimal power control (POPC) is applied in a way that the system spectral efficiency and energy consumption are optimized. The inventive approach relies on POPC described in A. Goldsmith, Wireless Communications University Press, 2005, for which all users achieve the SINR targets and the total transmit power of the mobile stations (MS_{S}) is minimized. In accordance with POPC the transmit power is adjusted such that a certain SINR is achieved at the receiver on each link.

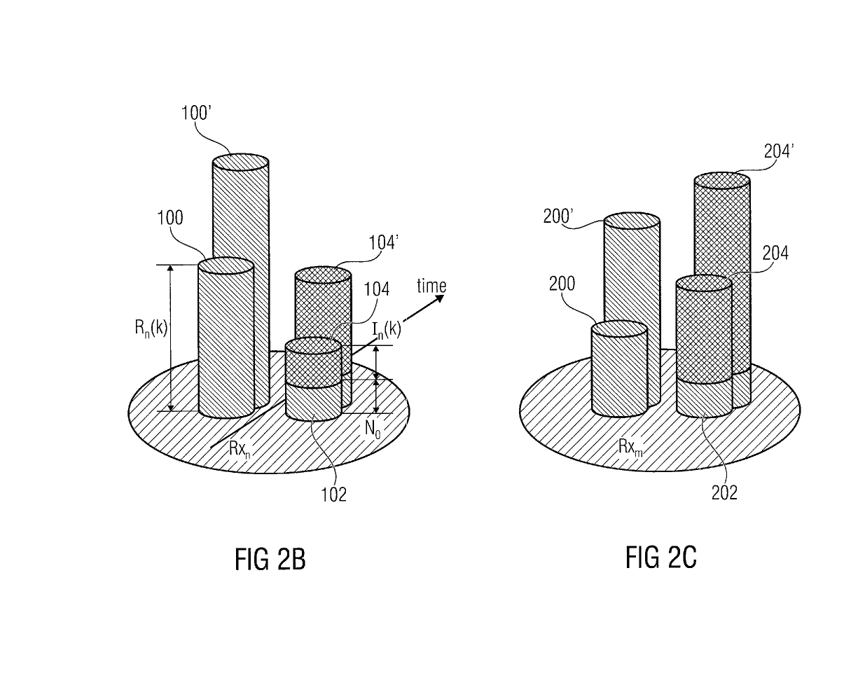

FIGS. 2A through 2C show schematic representations of a communication system. FIG. 2A depicts a schematic representation of two transmitters Txₙ and Txₘ transmitting signals. Further, two receivers Rxₙ and Rxₘ are shown receiving from the transmitters respective signals. In FIG. 2A the transmitter Txₙ serves the transmitter Rxₙ via a channel having a channel gain G_{n,n}. Likewise, the transmitters Txₘ, serves the receiver Rxₘ via a further channel having a channel gain G_{m,m}. However, the respective receivers are also subjected to interference in that receiver Rxₙ receives a signal from the transmitter Txₘ, via an interference channel having a channel gain G_{n,m}. Likewise receiver Rxₘ receives a signal from the transmitter Txₙ via an interference channel having a channel gain G_{m,n}. The transmit powers of the respective transmitters are denoted as Tₙ and Tₘ, respectively, and the received power or rather the power level of the signal received at the respective receivers is denoted Rₙ and Rₘ, respectively. The SINR at receiver Rxₙ is calculated as follows:

$${γ}_{n} = \frac{{R}_{n}}{{I}_{n} + {N}_{0}}$$

In accordance with G. J. Foschini and Z. Miljanic, “A Simple Distributed Autonomous Power Control Algorithm and Its Convergence,” IEEE Transactions on Vehicular Technology, vol. 42, no. 4, pp. 641-646, November 1991, for a Pareto optimum power control the power at a transmitter is updated as follows:

$${T}_{m} ( k ) = \frac{{Γ}_{m}}{{γ}_{m} ( k - 1 )} {T}_{m} ( k - 1 )$$

where:

Γₘ: SINR target

γₘ(k): achieved SINR

However, increasing the transmit power on one link induces interferences to the other link as is shown in FIGS. 2B and 2C. In FIG. 2B the received power 100 (Rₙ(k)) at a time instance k is indicated. Also the noise signal 102 (N₀) and the interference signal 104 (Iₙ) at time instance k are shown. In FIG. 2C the received power 200 at receiver Rxₘ, at instance k, the noise signal 202 (N₀) and the interference signal 204 at the receiver Rxₘ is shown at time instance k. The distance between the transmitter Txₙ and the receiver Rxₘ, is smaller than a distance between the transmitter Txₘ and the receiver Rxₙ. The distance between the transceiver Txₙ, and the receiver Rxₙ is shorter than a distance between the transmitter Txₘ and the receiver Rxₘ. The power received at receiver Rxₙ is higher than the power received at receive Rxₘ (see FIG. 2B and FIG. 2C). The noise remains substantially unchanged. Further, the interference signal at the receiver Rxₙ is smaller than the interference signal 204 at the receiver Rxₘ.

In case it is determined that a desired SINR is not achieved at the receiver Rxₘ the transmitter Tₓₘ may be controlled to increase its transmit power as is shown at 200′ in FIG. 2C. However, this yields a higher interference signal at the receiver Rxₘ as is shown at 104′ in FIG. 2B. Further, in case the transmit power of the transmitter Txₙ is increased as is shown at 100′ in FIG. 2B, for example for obtaining a desired SINR at the receiver Rxₙ this also increases the interference at the receiver Rxₘ as is shown at 200′. Thus, Pareto optimal power control is a non-trivial task.

In accordance with the inventive approach, users are scheduled in such a manner that each MS only has a single interferer in each neighboring cell (i.e. the same RBs (resource blocks) are assigned to a single MS in each cell) such that POPC can be applied directly to each group of MS_{S}. For allowing POPC to be applied to a group of interfering MS_{S}, the following condition holds:

P*=(I−F)⁻¹u iff ρ_{F}<1, (1)

where P* is the Pareto optimum power vector, I is the identity matrix, u is the vector of noise power scaled by the SINR targets and channel gains, F is the interference matrix, and ρ_{F} is the Perron-Frobenius (i.e., maximum absolute) eigenvalue of F. If a group of MS_{S} interfering with each other can fulfill the condition in Eq. (1), then POPC is utilized and each MS is allocated in optimum transmit power. To be able to schedule users in this way, the condition set forth in Eq. (1) needs to be formulated such that the network can directly utilize available information, i.e., path gains and SINR targets. After a derivation, the feasibility condition can be formulated as follows:

F₁₂F₂₁+F₁₃F₃₁+F₂₃F₃₂+F₁₂F₂₃F₃₁+F₁₃F₂₁F₃₂<1, (2)

where

$${F}_{ij} = \frac{{γ}_{i}^{*} {G}_{j , {v}_{i}}}{{G}_{i , {v}_{i}}}$$

are the elements of the interference matrix F,

γᵢ* is the target SINR of MS i, and

G_{j,v}_{ᵢ} is the path gain between MS j and the BS vᵢ of MS i.

Thus, the feasibility condition is expressed in terms of path gains and SINR targets, and the users can be scheduled accordingly.

To utilize Eq. (2) the scheduler needs to be aware of both the desired link and interfering link gains of the MS_{S} in the system. Each of the MS_{S} can estimate its path gains to its own and neighboring BSs using the reference signals in the downlink, and can report back to the BS on uplink control channels. The BSs in question can then share this information among each other over the network backbone, for example, the X2 interface in LTE. The information may either be passed to a higher architecture level (for example, the Serving Gateway (S-GW)/Mobility Management Entity (MME) in LTE) or to a single nominal BS so that the appropriate MS groups can be calculated according to Eq. (2) and the scheduling commands can be signaled to the individual BSs.

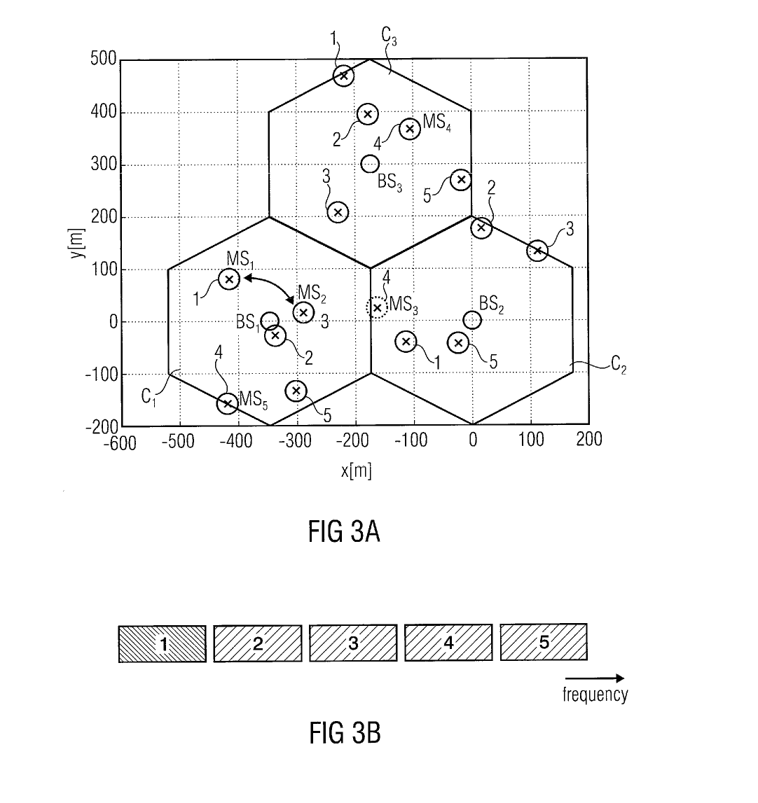

An example for the combination of power control, scheduling and resource partitioning in accordance with embodiments of the invention will be described in the following on the basis of FIGS. 3A and 3B, in which FIG. 3A shows a schematic representation of a three-cell network and FIG. 3B shows the available resource blocks (RBs), more specifically five different frequencies or frequency bands that may be allocated to the respective users. In FIG. 3A, three-cells C₁ to C₃ are shown each comprising a respective base station BS₁ to BS₃. Each of the cells C₁ to C₃ comprises five mobile stations. During scheduling appropriate user pairs are determined so that all links may coexist, i.e. a desired SINR target is met. In POS, when there are multiple users per cell (see cells C₁ to C₃ of FIG. 3A), the MS_{S} may be scheduled such that the number of groups of interferers fulfilling the condition (2) is maximized. This is done by iterating through all combinations of MS_{S} in the cells, and allocating the RBs such that the combinations of MS_{S} fulfilling the condition are scheduled as interferers. If it is possible to schedule all users in the system such that for each group of the interferers the condition (2) is fulfilled, then with POPC every user (MS) will achieve its target SINR and the total system power will be minimized.

An example of such a scheduling instance is shown in FIG. 3A, and in each cell the same resource blocks RBs are assigned to each MS in a group (and, clearly, a different set of RBs is assigned for each group). Then, after POPC is applied, each MS in each group will achieve its SINR target with Pareto optimal transmit power. For example, in FIG. 3A in each cell C₁ to C₃ a resource block is assigned only once, as can be seen from the respective numbers 1 to 5 assigned to the respective mobile stations in the cells C₁ to C₃.

The above-described scheduling process may comprise swapping the RB assignment between two users in one cell, which may result in a different interference condition in adjacent cells so as to meet the condition (2). For example, in FIG. 3A initially resource block 3 might have been assigned to mobile station MS₁, and resource block 1 might have been assigned to mobile station MS₂. However, this assignment did not fulfill condition (2) so that during the scheduling process in cell C₁ the resource blocks 1 and 3 were swapped so that mobile station MS₁ has assigned thereto resource block 1 (instead of resource block 3), and mobile station MS₂ has assigned thereto resource block 3 instead of resource block 1) so that for the allocation depicted in FIG. 3A condition (2) is fulfilled.

However, there may be situations in which, due to the position of some MS_{S}, for example at a cell-edge, these users may not be able to form a group of interferers that satisfies the condition for POPC. In this case, one or more links need to be switched off in order to allow potential interferers to be scheduled and to achieve the desired SINR targets. FIG. 3A shows an example for such a link removal or switching off of a link because the group of mobile stations having allocated therewith resource block 4, namely mobile stations MS₃ to MS₅ do not form a group of interferers that satisfies the above-mentioned feasibility condition for POPC. Thus, in accordance with a stepwise removal (SR) algorithm in accordance with an embodiment of the invention, one or more links of the mobile station MS₃ to the base stations BS₁ to BS₃ are removed and, therefore, in FIG. 3A mobile station MS₃ is shown with a dotted circle. Removing one or more links for the mobile station allows the other two mobile stations MS₄ and MS₅ to achieve their SINR targets (updated).

Turning off any link may harm the system spectral efficiency so that in accordance with an embodiment the SINR targets of the interferers will be updated to “cover” the removed spectral efficiency from the excluded link. By this mechanism, POPC can still be applied, with one or multiple links, if needed, removed, so that the spectral efficiency is maintained and that minimum transmit power usage is ensured.

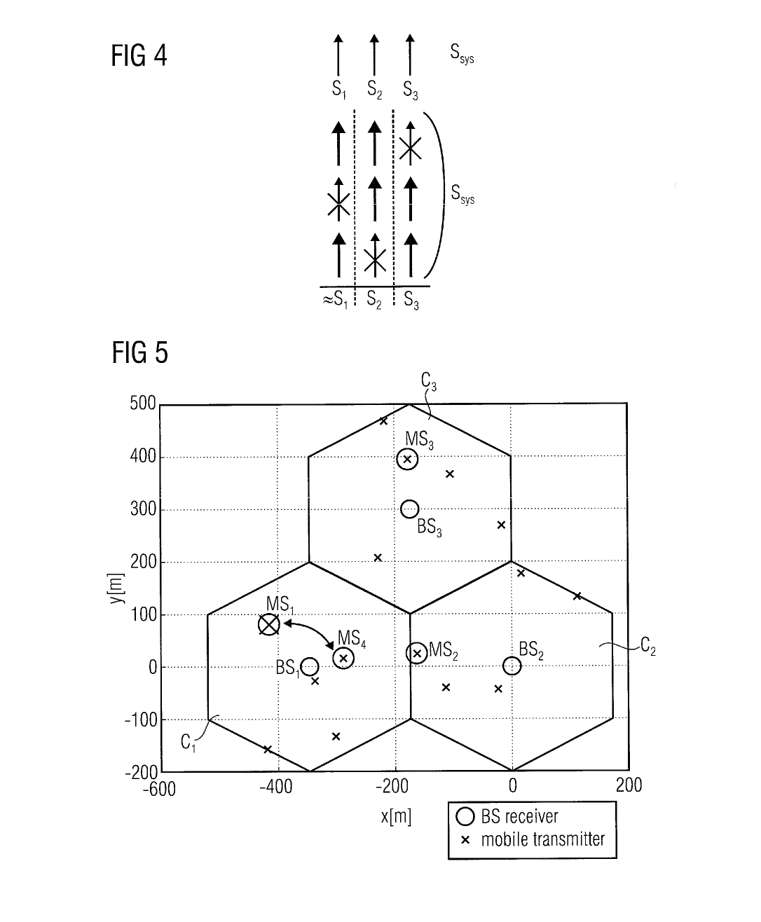

An example of the SR algorithm is shown in FIG. 4 with SINR target updates over multiple time slots. As is shown in FIG. 4, over multiple time slots S₁ to S₃ for a mobile station each of the three links is removed once, as is shown by the dashed arrow having the ‘x’. At the same time, the SINR targets (and consequently the spectral efficiency) of the two remaining links are augmented as is indicated by larger, bold arrows. By this approach, in each time slot and over all time slots (in the example shown over three time slots) the spectral efficiency S_{sys} is maintained. Furthermore, over three time slots each individual MS can achieve its target spectral efficiency, because the two inflated transmissions compensate for the loss of the removed transmission. Hence, both the system and the individual spectral efficiencies are maintained through the SINR target updates in the SR algorithm, while the link removals in each slot allow for scheduling of the other two users.

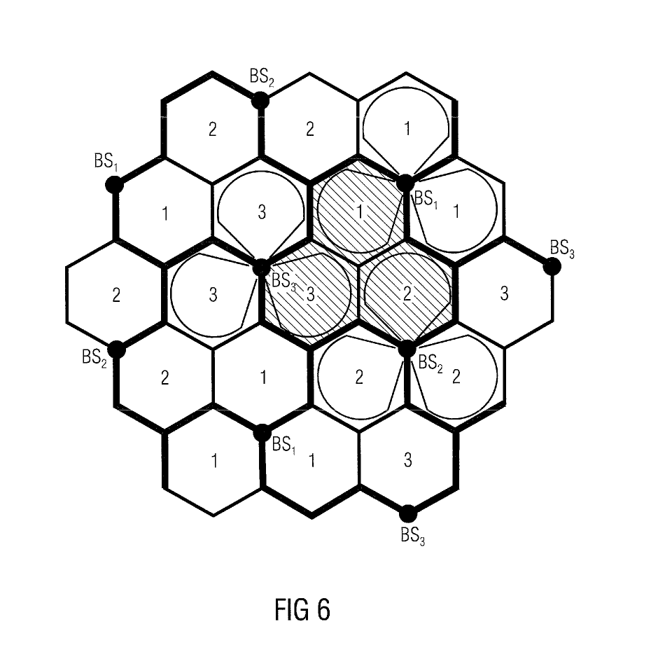

An example of an algorithm for combined power control, scheduling and resource partitioning in accordance with the embodiments of the invention will now be described with regard to FIG. 5 showing a three-cell system as in FIG. 3A. The first step of the algorithm is a resource allocation step in which resource blocks are assigned to the respective users. In FIG. 5 the same resource is assigned to mobile stations MS₁ to MS₃ in the respective cells C₁ to C₃. In the power control step it is determined as to whether condition (2) is fulfilled for the group of mobile station MS₁ to MS₃. In case it is determined that ρ_{F}≧1, then at least one of the links in the group does not achieve the desired SINR target. It is assumed in FIG. 5 that the links associated with mobile station MS₁ are removed and that only then the remaining mobile stations in the group achieve the desired ISINR target, i.e. ρ_{F}<1. Therefore, FIG. 5 shows mobile station MS₁ crossed out. The algorithm then returns to resource allocation step and a new set of mobile stations is selected so that the group now includes mobile station MS₂ to MS₄.

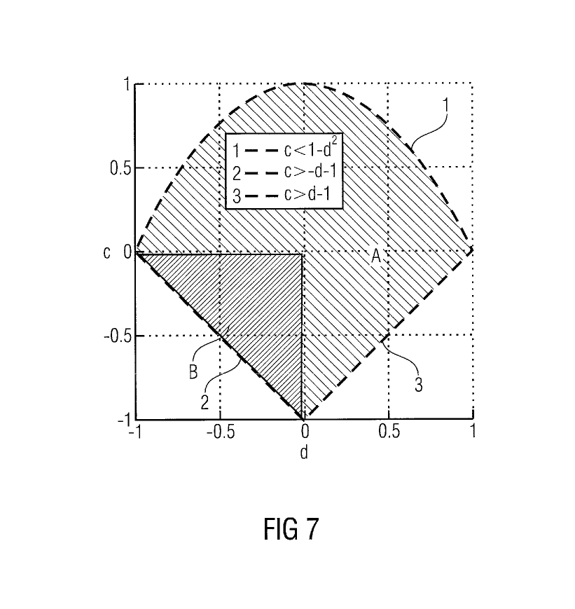

As described above, the POS scheduling approach is for a three-cell system, however, realistic scenarios comprise more than three cells. One option would be to derive the feasibility condition (2) for a larger number of cells and therefore apply the POS approach to a larger network, however, E. Jury, “A simplified stability criterion for linear discrete systems,” Proceedings of the IRE, vol. 50, no. 6, pp. 1493-1500, 1962 indicates that the feasibility conditions for even a four-cell scenario are excessively complex so that the just-mentioned extension to larger networks is not practical. In accordance with embodiments of the invention this problem is solved by an approach tessellating the three-cell POS over a network of any dimension. This is described with regard to FIG. 6 depicting a sectorized cellular network where a three-cell scheduler is tessellated over the cells in such a manner that three neighboring sectors/cells with interfering beams are grouped so that POS can be applied. In the sectorized cellular network of FIG. 6 universal frequency reuse is applied, and the different numbers in the respective cells indicate which BS is serving the cells. By grouping three cells with coinciding beam patterns (see the shaded cells in FIG. 6) POS can be applied to these three cells, and the cluster will be relatively shielded from neighboring sectors' interference due to the nature of the beam pattern. This clustering is then tessellated over the network such that POS can be applied separately in each of these clusters without overly excessive co-channel interference (CCI) from the surrounding cells thereby allowing the MS_{S} to achieve the transmission requirements.

In the following a detailed embodiment of the inventive approach will be described. In Pareto optimal power allocation, given a feasible link allocation, i.e., ρ_{F}<1, a vector P*=(I−F)⁻¹u can be found such that all users achieve their SINR requirements with minimal power. This is a highly desirable result which, depending on the locations of the interfering MS_{S}, may not be feasible in each case. Hence, by scheduling the users purposefully in such a manner as to maximize the number of feasible F matrices (in principle, there can be as many F matrices as there are RBs in the system), the system spectral efficiency can be maximized. A scheduler in accordance with embodiments of the invention allowing for this will now be described.

Since for a particular grouping of MS_{S} (on the same RB(s) in different cells) to be feasible ρF<1, it follows the modulus of all eigenvalues λi of F is also less than unity, i.e., |λᵢ|<1, ∀i=1, . . . , K. In other words, all eigenvalues lie within the unit circle.

In E. Jury, “A simplified stability criterion for linear discrete systems,” Proceedings of the IRE, vol. 50, no. 6, pp. 1493-1500, 1962, a simplified analytic test of stability of linear discrete systems is described. The test also yields the useful and sufficient conditions for any real polynomial to have all its roots inside the unit circle. Hence, this test can be directly applied to the characteristic function f_{F}(λ) of the matrix F, whose roots are the eigenvalues of F, and thus need to lie within the unit circle. The characteristic function of F, f_{F}, can be expressed as follows:

$$\begin{matrix}F = [ \begin{matrix}0 & {F}_{12} & {F}_{13} \\ {F}_{21} & 0 & {F}_{23} \\ {F}_{31} & {F}_{32} & 0\end{matrix} ] \\ Given \\ \begin{matrix}{f}_{{F}_{3}} ( λ ) = det ( F - λ I ) = 0 \\ = - {λ}^{3} + λ ( {F}_{12} {F}_{21} + {F}_{13} {F}_{31} + {F}_{23} {F}_{32} ) + {F}_{12} {F}_{23} {F}_{31} + \\ {F}_{13} {F}_{21} {F}_{32} \\ = {λ}^{3} + c λ + d\end{matrix} & ( 3 ) \\ Hence \\ c = - {F}_{12} {F}_{21} - {F}_{13} {F}_{31} - {F}_{23} {F}_{32} \\ d = - {F}_{12} {F}_{23} {F}_{31} - {F}_{13} {F}_{21} {F}_{32} & ( 4 )\end{matrix}$$

In E. Jury, “A simplified stability criterion for linear discrete systems,” Proceedings of the IRE, vol. 50, no. 6, pp. 1493-1500, 1962, the stability constraints for a polynomial of order K=3 are given as:

f(z)=a₃z³+a₂z²+a₁z+a₀, a₃>0

1) |a₀|<a₃

2) a₀²−a₃²<a₀a₂−a₁a₃

3) a₀+a₁+a₂+a₃>0, a₀−a₁+a₂−a₃<0 (5)

In E. Jury, “A simplified stability criterion for linear discrete systems,” Proceedings of the IRE, vol. 50, no. 6, pp. 1493-1500, 1962, the stability constraints are for a polynomial of degree n to have all its n roots within the unit circle, which is a condition for the stability of linear discrete systems. However, in accordance with the inventive approach the stability of the polynomial is not an issue, rather it is to be ensured that the roots, which are the eigenvalues of F, lie within the unit circle so that F becomes feasible.

The above conditions can now be applied to the characteristic function f_{F}_{₃} (λ)

f_{F}_{₃}(λ)=λ³+cλ+d

a₃=1, a₂=0, a₁=c, a₀=d,

1) |d|<1

2) d²−1<c→>c>1−d²

3) d+c+1>0→c>−d−1,

d−c−1<0→c>d−1 (6)

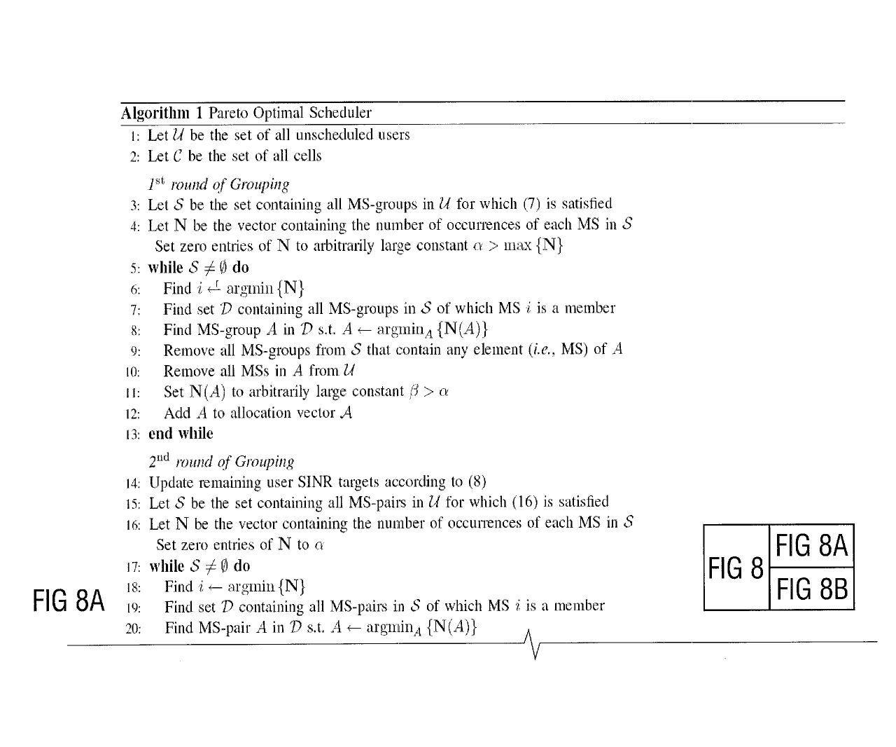

which describes the ranges of c and d for which F is feasible. These are shown in FIG. 7 by the dotted lines and the enclosed area. In FIG. 7 the enclosed area depicts the range of values for c and d in Eq. (4) for which all eigenvalues of F are within the unit circle. Due to the nature of c, d<0, the area B within the dotted lines 1, 2 and 3 denotes a specific feasibility area. However, since F_{i,j}>0, ∀i,j it is clear that both c, d<0, and hence the feasible area is substantially reduced (from the area A to the area B in FIG. 7), and the constraints are reduced to only a single one, such that the feasibility condition becomes:

3) c>−d−1

−F₁₂F₂₁−F₁₃F₃₁−F₂₃F₃₂>F₁₂F₂₃F₃₁+F₁₃F₂₁F₃₂−1

So, ρ_{F}<1 if:

F₁₂F₂₁+F₁₃F₃₁+F₂₃F₃₂+F₁₂F₂₃F₃₁+F₁₃F₂₁F₃₂<1 (7)

So, a group of MS_{S}, one in each cell (in the three-cell scenario), is feasible if the condition in Eq. (7) is fulfilled. This is dependent on the individual desired and interfering path gains, along with the SINR targets of the users. Therefore, a scheduler may make use of this condition to schedule users such that the number of feasible groups of MS_{S} is maximized, hence also maximizing the spectral efficiency of the system.

In both POPC and the Foschini-Miljanic algorithm (an iterative implementation of POPC and described in G. Foshini, Z. Miljanic, “A Simple Distributed Autonomous Power Control Algorithm and Its Convergence,” IEEE Transactions on Vehicular Technology, vol. 42, no. 4, pp. 641-646, November 1993), if ρ_{F}≮1 then no solution is available, and hence P→0 or P→(Pₘₐₓ, . . . , Pₘₐₓ)^{T}, respectively. In these cases, either none of the links will transmit, or transmit with (most-likely) too much power, and hence these solutions are suboptimal.

To address this problem is to successively remove single links from the group of interfering MS_{S}, until an F is achieved with ρ_{F}<1. At each step, the link is removed that is causing the largest interference to the other users, i.e., the column of F with the largest sum (both the column and the corresponding row are removed from F). However, turning off one of the links will harm the system spectral efficiency, and hence, in accordance with embodiments, an update function is provided to amend the SINR targets of the remaining links such that the system spectral efficiency does not suffer:

$${γ}_{( 1 ) , up}^{*} = \frac{{\prod }_{j}^{K} ( 1 + {γ}_{j}^{*} )}{1 + {γ}_{( 2 ) , up}^{*}} - 1 , \qquad ( 8 )$$

where γ_{(i),up}* represents the updated SINR target of the i^{th} remaining link. Since Eq. (8) has infinite solutions, an additional condition on and γ_{(1),up}* such as a power minimization

Solve (8) s.t. min{γ_{(1),up}*+γ_{(2),up}*}, (9)

or an equal absolute SINR increase

Solve (8) s.t. γ_{(1),up}*−γ₍₁₎*=γ_{(2),up}*−γ₍₂₎*, (10)

may be used. Finally, when two links have been removed and only a single link remains,

$${γ}_{( 1 ) , up}^{*} = {\prod }_{j}^{K} ( 1 + {γ}_{j}^{*} ) - 1 \\ and \\ F = 0 , \\ {ρ}_{F} = 0 , \\ and \\ P = u = \frac{n {γ}_{( 1 ) , up}^{*}}{{G}_{1 , {v}_{1}}} . \qquad ( 11 )$$

Through this form of link removal, the system spectral efficiency can be maintained while maximizing the number of transmitting users according to the feasibility constraint ρ_{F}. Furthermore, it prevents the explosion of transmit powers that results from the Foschini-Miljanic algorithm, and the annihilation of links caused by POPC.

In the case that the scheduler is unable to find feasible groups for particular MS_{S} (due to e.g., location at cell-edge), the SR algorithm will turn off one of the links in a group of MS_{S}, resulting in a feasibility matrix F of size K−1×K−1, in the three-cell case 2×2:

$$F = [ \begin{matrix}0 & {F}_{12} \\ {F}_{21} & 0\end{matrix} ] \qquad ( 12 )$$

Hence, the characteristic function is given by

$$\begin{matrix}{f}_{{F}_{2}} ( λ ) = det ( F - λ I ) \\ = {λ}^{2} - {F}_{12} {F}_{21} = 0 \\ = {λ}^{2} + c\end{matrix} \\ c = - {F}_{12} {F}_{21} \qquad ( 13 )$$

Again from E. Jury, “A simplified stability criterion for linear discrete systems,” Proceedings of the IRE, vol. 50, no. 6, pp. 1493-1500, 1962, the stability constraints for a polynomial of order K−1=2 are

f(z)=a₂z²+a₁z+a₀, a₂>0

1) |a₀|<a₂

2) a₀+a₁+a₂>0, a₀−a₁+a₂>0 (14)

Applying these conditions to the f_{F}_{₂}(∥) yields

f_{F}_{₂}(λ)=λ²+c

a₂=1, a₁=0,a₀=c,

1) |c|<1

2) c+1>0→1>−c, (15)

and hence the feasibility condition is given by

$$\begin{matrix}2 ) \begin{matrix}1 > - c \\ 1 > {F}_{12} {F}_{21}\end{matrix} & So , {ρ}_{F} < 1 if \text{:} {F}_{12} {F}_{21} < 1\end{matrix} \qquad ( 16 )$$

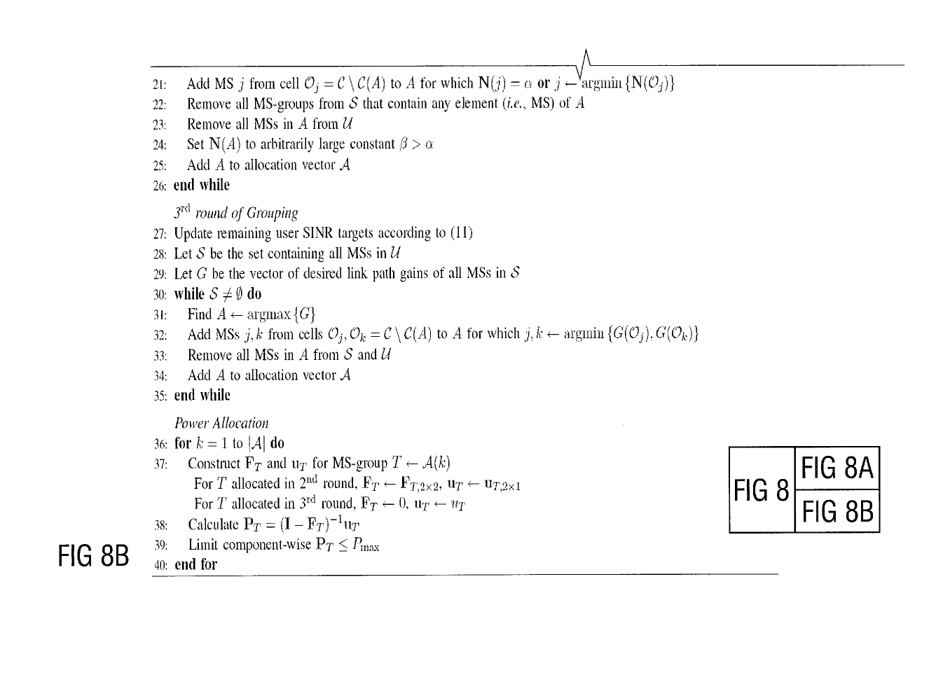

The goal of the scheduler is to maximize the “MS-groups”′ for which the feasible condition in (7) is satisfied, and the Pareto optimal power control can be applied. This is opposed to a random scheduler in which the assignment of RBs, and hence also the MS-groups, is performed in an arbitrary fashion. An embodiments of the POS algorithm is shown in FIGS. 8A and 8B and will now be described.

The scheduling algorithm is split into three allocation stages, corresponding to the number of cells considered (in this embodiment three) and hence the number of stepwise removals (plus 1) that are possible.

In the first round of grouping, the scheduler searches through all combinations of three MS_{S}(i.e., one in each cell), and adds each group to the set of candidates S that fulfils the feasibility condition (7). Since it is possible for certain MS_{S} to be part of multiple feasible groups, and some MS_{S} to not be part of any, to maximize the number of feasible combinations, those MS_{S} with the fewest feasible combinations will be scheduled first, before scheduling other groups and removing the possible partners. Hence, the MS_{S} with the least feasible groups is scheduled first along with the two feasible partners that have the least feasible groups, and so on until all MS_{S} in S have been scheduled/grouped. This completes the first round of grouping.

In the second round, the MS_{S} that have not been scheduled yet, i.e., those that did not make up any feasible combination in the first round grouping, are to be assigned. Because it is not possible to schedule any of these users in groups of 3 (as otherwise they would have been already scheduled in the first round), in this round groups will be allocated with one link deactivated. Furthermore, as in the stepwise removal algorithm described above the SINR targets are increased according to Eq. (8) to maintain the system spectral efficiency. Thus, similar as in the first round, the set S now denotes all “MS-pairs” that satisfy Eq. (16), and are hence feasible for allocation. Again, the MS(s) with the fewest number of feasible combinations are scheduled first, and to complete each group a MS is selected from the unscheduled cell that has either no feasible combinations, or at least the fewest of those in that cell remaining to be scheduled. This is done until all MS_{S} in D have been scheduled, completing the second round of grouping.

Finally, in the third round of grouping, where MS-groups with two deactivated links are scheduled, the scheduling becomes rather simple. The basic premise is that the activated link in each group should have the best path gain, so as to minimize its transmit power, and hence that of the group. Therefore, each of the remaining groups is constructed using the MS with the best path gain, and the MS in each of the two remaining cells with the worst path loss, until all MS_{S} have been scheduled. The SINR target is also updated, such that the system spectral efficiency can be maintained.

In the power allocation stage, F and u are constructed for each MS-group (these are of course sized accordingly for those groups allocated in the second or third round of grouping) and the Pareto optimal power allocation is calculated and assigned. The power of each MS is limited by the system's given maximum transmit power, which may reduce the optimality of some solutions, however is unavoidable. Through this scheduler, the system will attain the desired spectral efficiency, and if not, minimize the losses incurred.

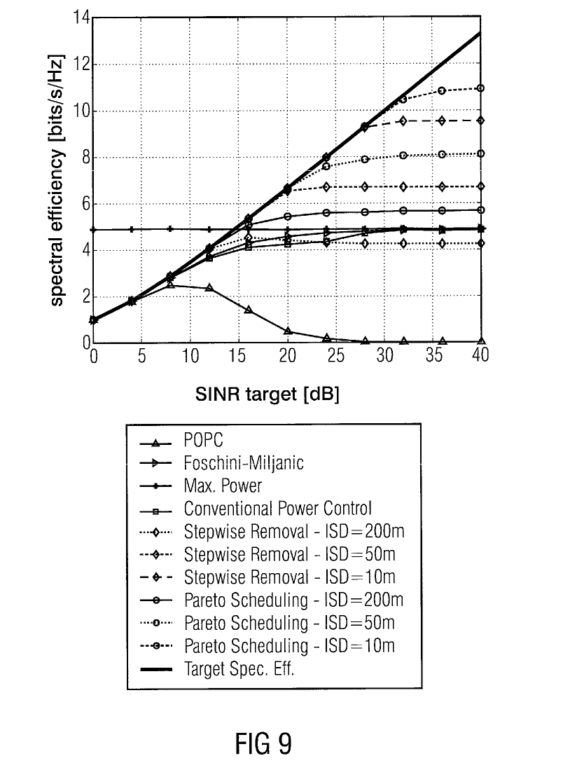

FIG. 9 shows the spectral efficiency results for the various power allocation techniques (random scheduling is used for all the power allocation techniques except POS) for varying SINR targets and inter-site distances (ISDs). As can be seen, POPC, the Foschini-Miljanic algorithm, open-loop power control and maximum power systems are constant for the various ISDs. The maximum power performance is constant over all SINR targets, and since the Foschini-Miljanic algorithm converges to this when the groupings are infeasible, it is clear why its performance is bounded. The Pareto optimal allocation suffers significantly from the random grouping, as the number of feasible groups disappears very rapidly with increasing SINR. Furthermore, the upper bound in FIG. 9 simply denotes the Shannon capacity of the given SINR target, i.e., the attainable spectral efficiency if all MS_{S} can be optimally scheduled.

The ISD is however a significant factor in the performance of the SR algorithm and POS as described in the embodiments above. The smaller the ISDs in the network, the better the performance of the power allocation strategies. When links are deactivated and, consequently, the SINR targets are increased to prevent loss of system spectral efficiency, the larger transmit powers needed to satisfy the γᵤₚ* are bound by Pₘₐₓ. Reducing the ISDs is equivalent to increasing Pₘₐₓ due to the greater desired link gains. Hence, POS and the SR algorithm will achieve the spectral efficiency target for much higher SINRs as the MS-groups with only two or one link(s) active are not bound by Pₘₐₓ. The differences that can be seen between POS and the SR algorithm represent the direct gains received through the grouping procedure in the Pareto scheduler. It is evident that gains over 1 bits/s/Hz are possible for varying ISDs. In general, it is evident that POS outperforms all other techniques for the scenarios (ISDs) investigated.

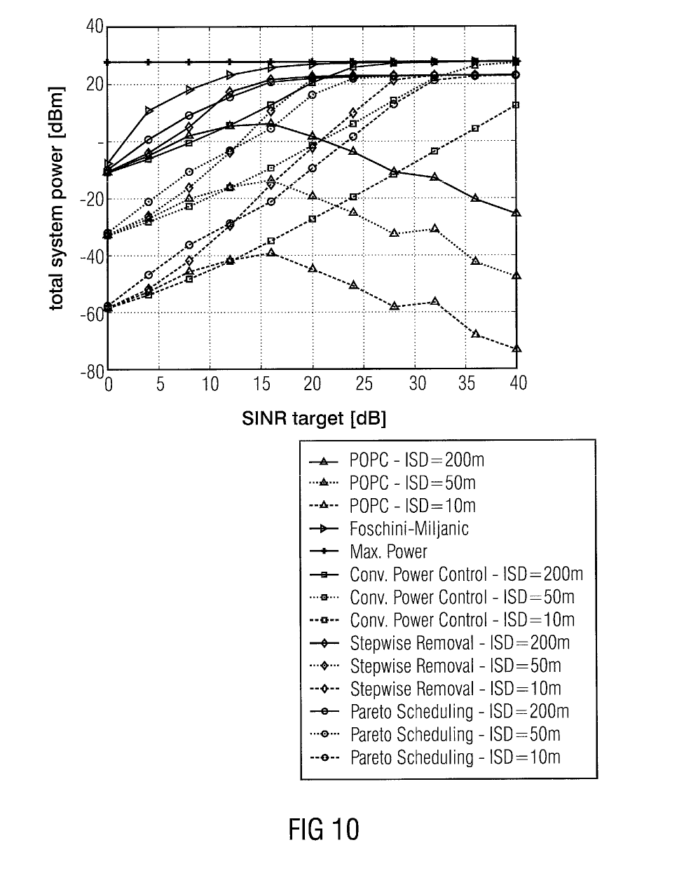

FIG. 10 shows a graph of the system power usage results for the various power control techniques. FIG. 10 shows the total system power usage. While POPC uses almost no power due to its low availability, the Foschini-Miljanic algorithm convergences to maximum power transmission. The system powers of POS and the SR algorithm are much lower than the other techniques (except for conventional power control, which however does not achieve the spectral efficiency target of the system). The reduction in transmit power for smaller ISDs is explained by the reduction in the desired link gains. For each ISD the lower SINRs POS involves slightly more power than the SR algorithm, mainly because more users are being scheduled. This is, however, inverted after γ*=12 dB, as here the (most likely) single remaining link per group involves more power in the SR algorithm than the two or three links scheduled in POS. In the end, however, both converge to (for all ISDs) Pₘₐₓ/3. From FIGS. 9 and 10 it is clear that POS delivers close to optimal performance in terms of spectral efficiency, and performs very well in terms of power usage over a wide range of SINR targets.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed. Generally, embodiments of the present invention can be implemented as a computer program product with a program code, the program code being operative for performing one of the methods when the computer program product runs on a computer. The program code may for example be stored on a machine readable carrier. Other embodiments comprise the computer program for performing one of the methods described herein, stored on a machine readable carrier. In other words, an embodiment of the inventive method is, therefore, a computer program having a program code for performing one of the methods described herein, when the computer program runs on a computer. A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein. A further embodiment comprises a computer having installed thereon the computer program for performing one of the methods described herein. In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

What is claimed is:

1. A method for scheduling users in a cellular environment such that a Pareto optimal power control can be applied, wherein in each cell of the cellular environment there are a plurality of users, the method comprising:
scheduling users such that a number of groups of interfering users from different cells which fulfill a feasibility condition for the Pareto optimal power control is maximized,
wherein scheduling comprises:
searching all combinations of users, each combination comprising one user in a neighboring cell;
adding to a set of candidates each combination which fulfills the feasibility condition; and
allocating the users until all users in the set of candidates have been allocated, wherein allocating starts with users being part in the fewest combinations, and
wherein for a three cell scenario the feasibility condition is as follows:
F₁₂F₂₁+F₁₃F₃₁+F₂₃F₃₂+F₁₂F₂₃F₃₁+F₁₃F₂₁F₃₂<1
where
$${F}_{ij} = \frac{{γ}_{i}^{*} {G}_{j , {v}_{i}}}{{G}_{i , {v}_{i}}}$$
are the elements of the interference matrix F,
γᵢ* is the target SINR of user i, and
G_{j,v}_{ᵢ} is the path gain between user j and the BS vᵢ of MS i.

2. The method of claim 1, wherein scheduling the users is repeated until all users in the set of candidates have been scheduled.

3. The method of claim 1, wherein, in case there are users which are not part of any combination fulfilling the feasibility condition, scheduling further comprises:
deactivating for each user one link;
adapting a SINR target for each user to maintain system spectral efficiency;
adding each combination of users which fulfills a modified feasibility condition to a further set of candidates; and
allocating the users until all users in the further set of candidates have been allocated, wherein the allocation starts with a user being part in the fewest combinations.

4. The method of claim 3, wherein said deactivating, adapting, adding and allocating is repeated for users not part of any combination fulfilling the modified feasibility condition until all links to users in neighboring cells have been deactivated.

5. The method of claim 1, further comprising:
in case of one or more users in a cell that cannot form a combination fulfilling the feasibility condition, switching off the links to users in neighboring cells.

6. The method of claim 5, wherein the links are switched off over a plurality of consecutive time slots, wherein the SINR target of the remaining links is changed for maintaining the system spectral efficiency.

7. The method of claim 6, wherein the SINR target of the remaining links is changed as follows:
$${γ}_{( 1 ) , up}^{*} = \frac{{\prod }_{j}^{K} ( 1 + {γ}_{j}^{*} )}{1 + {γ}_{( 2 ) , up}^{*}} - 1 ,$$
where γ_{(i),up}* represents the updated SINR target of the i^{th} remaining link.

8. The method of claim 7, further comprising:
grouping three cells with coinciding beam patterns to form a cluster substantially shielded from neighboring sectors' interference;
applying the scheduling the these three cells; and
tessellating the clusters over the cell environment, thereby applying the scheduling separately to each cluster.

9. The method of claim 1, comprising for each combination fulfilling the feasibility condition:
calculating the Pareto optimal power allocation and assigning it to the users.

10. A computer program product comprising instructions to perform a method of claim 1 when executing the instructions on a computer.

11. A scheduler for a wireless network comprising a plurality of cells, each comprising a plurality of users, the scheduler being configured to schedule the users in accordance with claim 1.

12. A wireless network comprising a plurality of cells, each comprising a plurality of users, and a scheduler of claim 11.
